(19) United States
(12) Patent Application Publication
(10) Pub. No.: US 2011/0242587 A1
(43) Pub. Date: Oct. 6, 2011

(54) IMAGE FORMING DEVICE SYSTEM, PRINTING SELECTION DEVICE, PRINT SERVER, IMAGE FORMING DEVICE AND SELECTION METHOD THEREOF

(75) Inventor: Hideaki FUKAYA, Shizuoka (JP)

(73) Assignees: Kabushiki Kaisha Toshiba, Tokyo (JP); Toshiba Tec Kabushiki Kaisha, Tokyo (JP)

(21) Appl. No.: 13/038,319

(22) Filed: Mar. 1, 2011

Related U.S. Application Data
(60) Provisional application No. 61/321,012, filed on Apr. 5, 2010.

(51) Int. Cl. G06K 15/02

(52) U.S. Cl. 358/1.15

(57) ABSTRACT

According to one embodiment, an image forming device system includes a client terminal connected to a network, a plurality of image forming devices that are connected to the network and can perform printing in response to a request for printing from the client terminal, and a device selection unit that selects the image forming device according to desired printing conditions, including a time after an image stabilization process, input from the client terminal or one of the image forming devices when there is a request for printing from the client terminal.

### CROSS-REFERENCE TO RELATED APPLICATION

This application is based upon and claims the benefit of priority from U.S. provisional Application No. 61/321,012, filed Apr. 5, 2010; the entire contents of which are incorporated herein by reference.

### FIELD

Embodiments of the present invention relate generally to an image forming device system connected to a network, a printing selection device, a print server, an image forming device, and a selection method thereof.

### BACKGROUND

A system in which data is sent from a client PC or the like to one of a plurality of printers connected to a network and printing output is obtained is known as a network printer system.

In this case, to the network, devices (here, collectively referred to as image forming devices) having various printing functions such as inexpensive low-functionality devices and high-functionality multi function peripherals are connected.

For an operator operating a client PC, printing may be performed by any image forming device as long as a desired printing output can be obtained. Even in this case, it is necessary in the related art for an operator to designate an image forming device which can perform the desired printing and then to allow the device to perform printing, which is inconvenient.

In addition, if an image stabilization process was performed well in advance, the mere desire for high quality printing does not satisfy the operator's expectation.

The present invention provides an image forming device system, a printing selection device, a print server, an image forming device, and a selection method thereof, capable of performing printing which an operator desires even if the operator does not designate an image forming device from a client terminal, and performing desired high quality printing.

### BRIEF DESCRIPTION OF THE DRAWINGS

FIG. 1 is a diagram illustrating the overall configuration example according to a first embodiment.

FIG. 2 is a diagram illustrating a configuration example of a print server according to the first embodiment.

FIG. 3 is a diagram illustrating a configuration example of an image forming device according to the first embodiment.

FIG. 4 is a diagram illustrating an example of a screen for inputting desired printing conditions in a client PC according to the first embodiment.

FIG. 5 is a flowchart illustrating an operation according, to the first embodiment.

FIG. 6 is a diagram illustrating the overall configuration example according to a second embodiment.

FIG. 7 is a diagram illustrating a configuration example of an image forming device according to the second embodiment.

FIG. 8 is a diagram illustrating an example of a screen when desired input conditions are displayed on an operation panel in the image forming device according to the second embodiment.

### DETAILED DESCRIPTION

According to an embodiment of the present invention, there is provided an image forming device system including a client terminal connected to a network, a plurality of image forming devices that are connected to the network and can perform printing in response to a request for printing from the client terminal, and a device selection unit that selects the image forming device according to desired printing conditions, including a time after an image stabilization process, input from the client terminal or one of the image forming devices when there is a request for printing from the client terminal.

Hereinafter, embodiments of the present invention will be described with reference to the accompanying drawings.

### First Embodiment

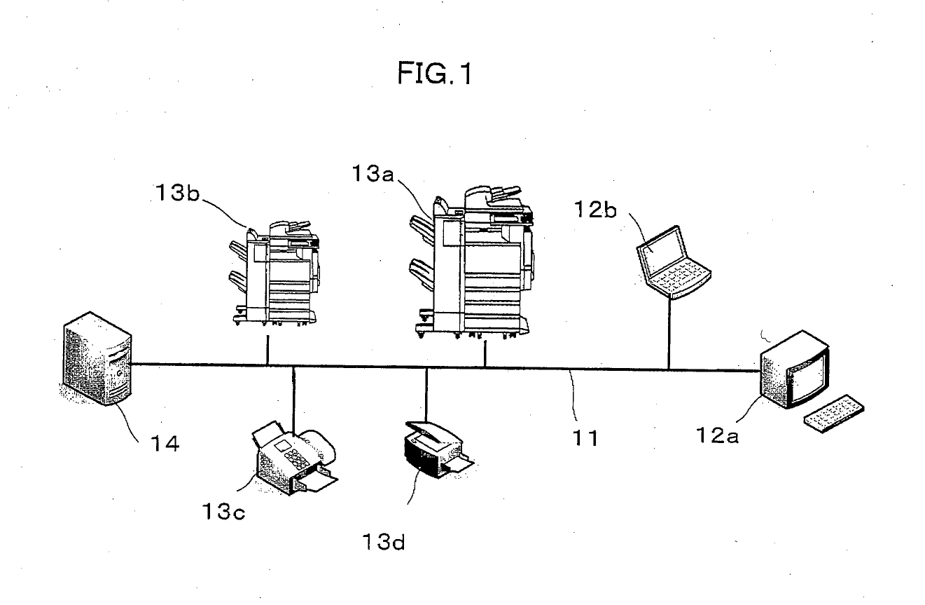

FIG. 1 shows a configuration example of the overall system. This image forming device system includes client PCs 12a and 12b which are connected to a network 11 and which can instruct printing, image forming devices 13a, 13b, 13c and 13d which actually perform printing, and a print server 14 which controls which image forming device performs printing.

For example, the client PC 12a is a desktop computer, and the client PC 12b is a notebook computer. The image forming device 13a is, for example, a multi function peripheral (MFP) which can perform various processes such as a function of performing high resolution color and monochrome printing, a function of copying an original paper, a function of communicating with external devices, and a function of transmission and reception and performing printing as a facsimile device. In addition, the image forming device 13b is, for example, a multi function peripheral (MFP) having a function of performing monochrome and color copying, a function of transmitting and receiving facsimile data and printing received data, and the like. The image forming device 13a largely includes, for example, as shown in FIG. 3, a copying data generation unit 31 which generates a latent image for copying from original paper, a transmission and reception unit 32 which transmits and receives signals to and from external devices and temporarily stores transmitted and received data, a printing data storage unit 33 which stores printing data, and a printing unit 34 which performs printing when printing is required.

The image forming device 13c is, for example, a facsimile device which has a function of transmitting and receiving a facsimile and printing received data in monochrome. The image forming device 13d is, for example, a small-size color copier having a function of copying original paper in color. These image forming devices 13a, 13b, 13c and 13d all correspond to the network, and if there is a request for printing from the client PC connected to the network 11, can print designated data.

The meaning that color printing is possible naturally includes a monochrome printing function. The number of the client PCs and the number of the image forming devices are not limited to two and four shown in FIG. 1, but may respectively three or more, three or five or more. One image forming device is selected, and thus the image forming devices may be provided in plurality, but the client PC may be provided singly.

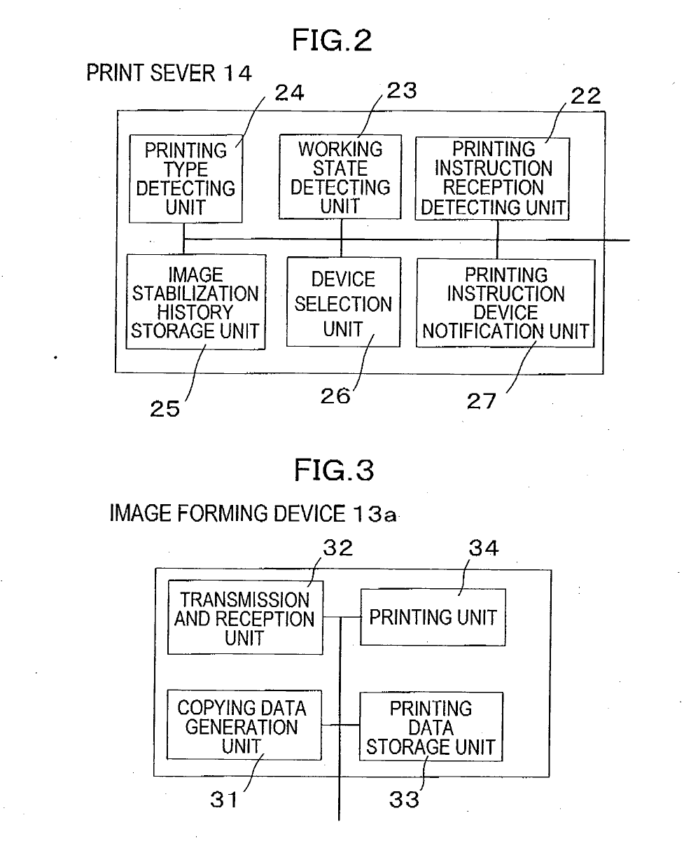

The print server 14 ascertains printing characteristics for all the image forming devices in advance, and monitors working states thereof at all times. FIG. 2 shows an electric configuration example of the print server 14. The print server 14 includes a printing instruction reception detecting unit 22 which detects a printing instruction control signal from the client PCs 12a and 12b along with data for desired printing conditions, a working state detecting unit 23 which detects working states of each image forming device, a printing type detecting unit 24 which detects printing types in advance in order to grasp characteristics of each image forming device, an image stabilization history storage unit 25 which stores a history as to when each image forming device performed an image stabilization process, a device selection unit 26 which selects an image forming device satisfying printing conditions added to the printing control signal received from the printing instruction reception detecting unit 22, and a printing instruction device notification unit 27 which instructs the image forming device selected by the device selection unit 26 and the client PC which makes a request for printing to send and receive printing data.

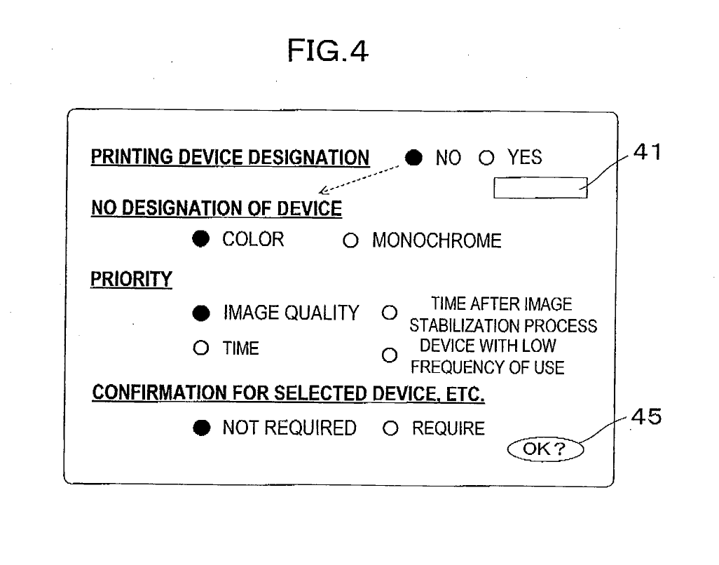

The printing instruction reception detecting unit 22 receives a printing instruction control signal and data for desired printing conditions from each client PC. FIG. 4 shows a screen on a display device when the client PC makes a request for printing. In the uppermost part, there is an option whether or not to designate a printing device, and thereafter, there is an option whether to perform monochrome printing or color printing, if a device is not designated. Under this, if a printing device is not selected, there is an option as to priority, and thereunder, there is an option as to whether or not an operator requires to confirm a selected device or the like. In the right part thereunder, there is a confirmation button 45 as to whether or not all printing conditions are input. By clicking the confirmation button 45, the print server 19 selects and instructs an image forming device for printing under the input conditions.

In the column “priority”, for example, the following items are displayed. The first is “image quality”, the second is “time”, the third is “time after image stabilization process”, and the last is “device with a low frequency of use”. If “image quality” is prioritized, the image forming device with the highest image quality is selected, and if “time” is selected, the image forming device which performs printing in the shortest time is selected. In addition, if the “time after image stabilization process” is designated by an operator, an image forming device in which the time after an image stabilization process is performed is the shortest is selected. Further, if the “device with a low frequency of use” is selected, the least recently used image forming device is selected from image forming devices connected to the network.

If printing is performed, overtime, various deteriorations in images such as variations in image quality or misalignment of images occur. A process for obtaining an image of a predetermined quality by correcting the deteriorations in the image is the image stabilization process. The image stabilization process is performed for the monochrome printing as well as the color printing.

The above-described priority is considered when the above-described printing device is not designated, color or monochrome is selected, and image forming devices satisfying these conditions exist in plurality. For example, in the case where a device is not designated and color is selected, if an image forming device satisfying the conditions exists singly, the column priority is displayed in white so as not to be input.

When making a request for printing from this screen, an operator first instructs desired printing conditions. To begin with, it is initially selected whether or not an image forming device performing printing is directly designated.

If an image forming device performing printing is directly designated, the circle in front of “YES” is checked. In this case, a model name of the designated image forming device is input in the column 41 directly thereunder. In this case, the selection of color and monochrome, and the priority, which are displayed below, are displayed in white so as not to be selected.

If an image forming device performing printing is not designated, the circle in front of “NO” is checked. At this time, “YES” cannot be selected and a model name of an image forming device cannot be input thereunder as well.

In this case, color and monochrome can be selected in the case where a device is not designated, and any one of the image quality, the time, and the time after image stabilization process, and the device with a low frequency of use belonging to the priority thereunder can be selected. In this example, only the one item can be selected, but two or more items may be selected.

The working state detecting unit 23 is a device which detects working states of all of the image forming devices connected to the network 11, and if there is a request for printing from the client PC as described below, sends a query signal to the image forming devices at that time, and detects working states thereof. The respective image forming devices may send working states thereof to the print server 14. The device with a low frequency of use can be selected by the working state detecting unit 23 ascertaining the working states of the respective image forming devices.

The printing type detecting unit 24 stores printing characteristics for the image forming devices connected to the network 11. The printing characteristics include, for example, performing printing in color or only in monochrome, in a ink jet type, in an electrostatic type, or in a laser type, forming an image by overlapping respective colors through transfer after being formed or by simultaneously forming colors when color printing is performed, performing or not performing high image quality printing, and the like. The printing characteristics are referenced when the device selection unit 26 selects an image forming device performing printing.

FIG. 4 shows a screen for inputting desired printing conditions displayed on the client PC.

The “image quality” and “time” in the column “priority” on this screen are selected based on a printing type which is mainly detected by the printing type detecting unit 24. In the same manner, the “time after image stabilization process” is selected based on an output from the image stabilization history storage unit 25.

The image stabilization history storage unit 25 stores a history as to when an image stabilization process for color and monochrome is performed. This history is referenced when the device selection unit 26 selects an image forming device in a case where the time after image stabilization process is selected as the priority when an image forming device is selected.

The device selection unit 26 selects an appropriate image forming device from a plurality of image forming devices according to the printing conditions from the client PC based on information stored in the working state detecting unit 23, the printing type detecting unit 24, and the image stabilization history storage unit 25.

The printing instruction device notification unit 27 instructs the image forming device selected by the device selection unit 26 and the client PC requesting the printing to transmit printing data, or notifies the client PC when there is no selected image forming device or there is only one image forming device.

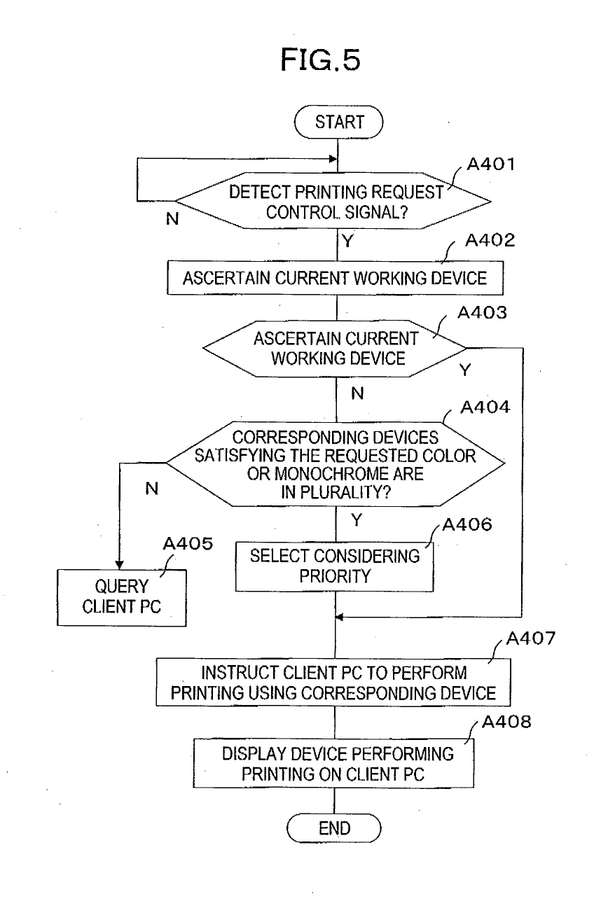

Next, an operation in this embodiment when printing is instructed from the client PC will be described with reference to FIG. 5 showing a flowchart.

For example, it is assumed that an operator using the client PC 12a wishes to print documents created in advance, or mails or documents which are received from external devices.

If the operator makes a request for printing, first, the client PC 12a sends a printing request control signal for making the request for printing to the print server 14 and displays the screen shown in FIG. 4 on the display screen of the client PC. The operator inputs desired printing conditions from the screen shown in FIG. 4.

If the printing instruction reception detecting unit 22 of the print server 14 detects the printing request control signal sent from the client PC 12a in ACT A401, the working state detecting unit 23 queries the respective image forming devices 13a to 13d about working states thereof in ACT A402. The working state means that the respective image forming devices are in a state where printing is possible at all times. Devices which are not in the state where printing is possible include devices which cannot be used due to a breakdown or paper jam, and devices which do not work due to being powered off.

The non-working state of an image forming device can be detected based on the lack of response to the query control signal sent to the image forming device. The client PC can ascertain a breakdown, or paper jam, of an image forming device based on a signal response to the query control signal from the client PC, which indicates a breakdown or paper jam.

In this way, the working state detecting unit 23 of the print server 14 ascertains working states of all of the image forming devices in ACT A402. An image forming device performing printing is selected from currently working image forming devices.

Next, in ACT A403, it is detected if an image forming device by which printing is desired to be performed is directly designated. From the screen shown in FIG. 4 of the client PC 12a, the operator inputs desired printing conditions. For example, if the operator wants the familiar image forming device 13d which is always used to perform printing, the operator checks “YES” in the column printing device designation, and inputs the model name of the image forming device 13d or a name given in advance in the square input column 41 directly thereunder.

The device selection unit 26 of the print server 14 detects that the image forming device performing printing is directly designated (ACT A403: Y), and, as shown in ACT A407, the client PC 12a is instructed to perform printing using the image forming device 13d. Specifically, the printing instruction device notification unit 27 sends a control signal indicating that printing is performed using this device to the image forming device 13d and the client PC 12a, and then data for printing is sent to the image forming device 13d from the client PC 12a so as to perform printing.

In the state where “YES” is checked in the column designating the printing device on the screen in FIG. 4, the lower part of the screen in FIG. 4 are in white and in a state of not being input.

On the other hand, if the operator checks “NO” in the column “printing device designation” on the screen in FIG. 4, input in the input column under “YES” cannot be performed.

When “NO” is selected in the column “printing device designation”, an input in the column “no designation of device” and the column “priority” thereunder can be performed.

In the column “no designation of device”, it is determined whether an input regarding the request for printing is color or monochrome, and it is determined whether or not devices satisfying the request are in plurality. This determination is performed by the device selection unit 26 of the print server 14.

For example, if color is selected in ACT A404, only one image forming device can perform color printing among the image forming devices connected to the network 11, the determination is negative in ACT A404, and the flow goes to ACT A405. Here, the printing instruction device notification unit 27 which receives the content that only one image forming device exists from the device selection unit 26 sends to the client PC 12a a signal indicating that only one image forming device capable of performing color printing exists and asking whether printing is to be performed using the one image forming device.

Regardless of color printing being desired, in such a case where there is no image forming device capable of color printing as well, the printing instruction device notification unit 27 sends a signal for querying such content to the client PC 12a in ACT A405.

If a plurality of image forming devices is connected to the network 11 as described above, it is assumed that the operator operating the client PC clicks “color” in the column “no designation of device” from the screen shown in FIG. 4. In this case, the image forming devices excluding the image forming device 13c can perform color printing, and thus corresponding devices exist in plurality. Therefore, the determination in ACT A404 is affirmative, and in successive ACT A406, an appropriate image forming device is selected based on the information input in the column “priority” in FIG. 4. The device selection unit 26 also performs this selection.

In the column “priority” in FIG. 4, for example, four items, “image quality”, “time”, “time after image stabilization process”, and “device with low frequency of use” are listed. The “image quality” is checked when image printing with best image quality is desired. The “time” is checked when printing in the shortest time is desired. The “time after image stabilization process” is selected when printing is desired using an image forming device in which the lapse time after the image stabilization process is performed is the shortest.

In this way, in ACT A406, the device selection unit selects an image forming device satisfying the condition according to the input in the input column of the priority. If “not required” is selected in the column “confirmation for selected device, etc.” on the input screen in FIG. 4, the flow goes to ACT A407 as it is, and a corresponding device and the client PC are instructed to perform printing using the corresponding device. In response to this instruction, printing data is transmitted from the client PC 12a to the corresponding device performing printing, for example, the printing data storage unit 33 of the image forming device 13a. The printing data transmitted to the printing data storage unit 33 is printed by the printing unit 34.

In this way, since an image forming device performing printing is selected and printing data is transmitted to the corresponding device from the client PC, there is an advantage in that the printing data is not required to flow in advance to the network and the client PC can efficiently transmit the printing data to the image forming device performing printing.

However, the client PC 12a may first send the printing data to the print server 14 before an image forming device performing printing is selected, and, after an image forming device performing printing is selected, the printing data may be transmitted to the corresponding device.

In ACT A408, the display screen of the client PC displays that the corresponding device is performing printing.

In addition, if “required” is selected in the column “confirmation for selected device, etc.” on the desired printing input screen of the client PC shown in FIG. 4, particularly, if a plurality of image forming devices is selected in ACT A406, names of the image forming devices are displayed on the display screen of the client PC, and the operator is made to select which image forming device performs printing. If “required” is selected in the column “confirmation for selected device, etc.”, even in a case where one image forming device is selected in consideration of the priority, the operator is made to confirm by displaying the image forming device on the display screen of the client PC 12a before printing is performed. If “required” is selected in the column “confirmation for selected device, etc.”, even in the case of one corresponding device, a name or the like of the corresponding device is displayed on the display screen of the client PC in ACT A405.

In ACT A404, if there are no image forming devices satisfying the conditions requested by the operator, even if “not required” is input in the column “confirmation for selected device, etc.” on the input screen in FIG. 4, a display indicating that there is no corresponding device is performed on the display screen of the client PC.

According to this embodiment, the client PC is not required to directly select an image forming device performing printing, and the print server can select an image forming device performing printing based on printing conditions input from the client PC.

In the embodiment, the operator inputs desired printing conditions from the client PC. However, desired printing conditions may be input from the operation panel of each image forming device.

In addition, the print server does not necessarily have the function of selecting an image forming device performing printing based on printing conditions desired by the operator operating the client PC. For example, one of the image forming devices may have such a selection function. This embodiment will be described below.

### Second Embodiment

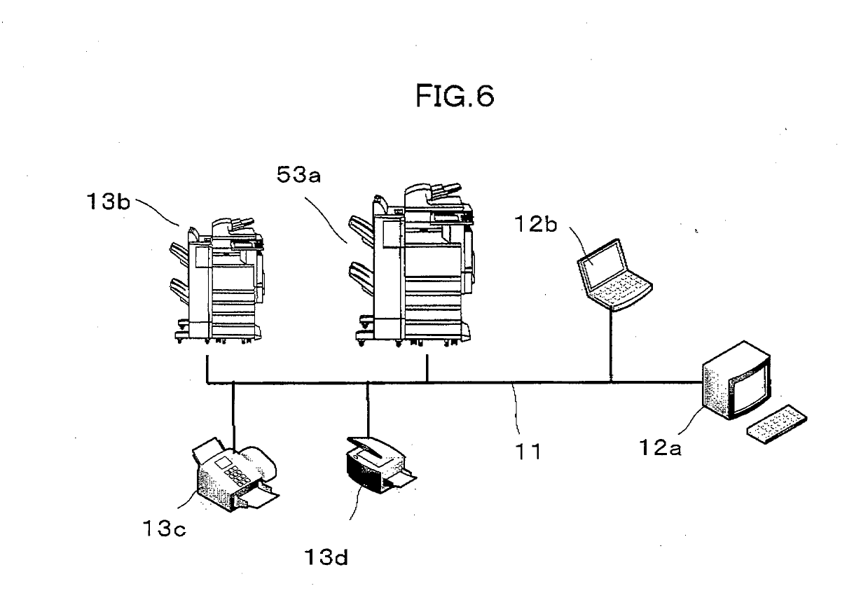

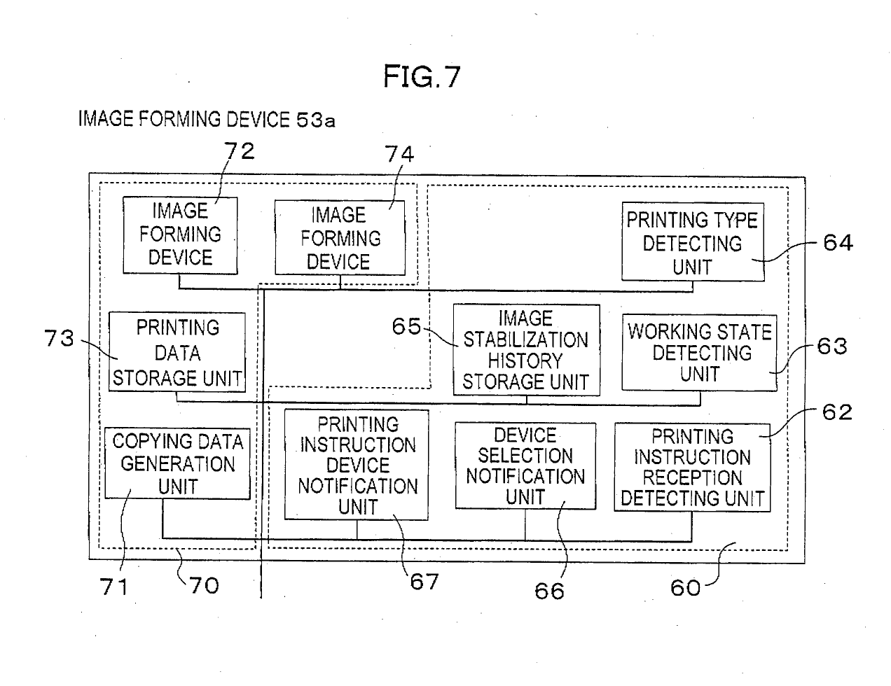

In this embodiment, FIG. 6 shows the overall configuration of an image forming device system. In this embodiment, the print server is not provided, and a high-functionality image forming device has the function of the print server. A configuration example of the image forming device is shown in FIG. 7.

Upon comparison with the system in FIG. 1, the image forming device system in this embodiment has no print server, and an image forming device 53a has the function of the print server. The image forming device 53a corresponds to the image forming device 13a in FIG. 1, and includes an image forming unit 70 which is originally included therein, and further a device selection printing instruction unit 60 which selects a device satisfying the conditions based on printing conditions desired by an operator of a client PC. Other image forming devices do not have parts for such a device selection function.

The device selection printing instruction unit 60 includes a printing instruction reception detecting unit 62 which detects a printing instruction control signal from the client PCs 12a and 12b along with data for desired printing conditions, a working state detecting unit 63 which detects the working states of each image forming device, a printing type detecting unit 64 which detects printing types in advance in order to grasp characteristics of each image forming device, an image stabilization history storage unit 65 which stores a history as to when each image forming device performed an image stabilization process, a device selection unit 66 which selects an image forming device satisfying printing conditions added to the printing control signal received from the printing instruction reception detecting unit, and a printing instruction device notification unit 67 which instructs the selected image forming device and the client PC which requests printing to perform printing.

The printing instruction reception detecting unit 62, the working state detecting unit 63, the printing type detecting unit 64, the image stabilization history storage unit 65, the device selection unit 66, and the printing instruction device notification unit 67 respectively correspond to and have the same functions as the printing instruction reception detecting unit 22, the working state detecting unit 23, the printing type detecting unit 24, the image stabilization history storage unit 25, the device selection unit 26, and the printing instruction device notification unit 27, which are shown in FIG. 2 in the print server 14.

As shown in FIG. 7, the image forming unit 70 of the image forming device 53a includes a copying data generation unit 71 which generates a latent image for copying from original paper when copying is performed, a transmission and reception unit 72 which transmits and receives signals to and from external devices and temporarily stores transmitted and received data, a printing data storage unit 73 which stores printing data, and a printing unit 74 which performs printing when the printing is required. The copying data generation unit 71, the transmission and reception unit 72, the printing data storage unit 73, and the printing unit 74 respectively have the same functions as the copying data generation unit 31, the transmission and reception unit 32, the printing data storage unit 33, and the printing unit 34 shown in FIG. 3.

Therefore, the second embodiment corresponds to a system configured such that the image forming device 53a includes the respective units, the printing instruction reception detecting unit 22, the working state detecting unit 23, the printing type detecting unit 24, the image stabilization history storage unit 25, the device selection unit 26, and the printing instruction device notification unit 27, which are included in the print server 14 in the first embodiment shown in FIGS. 2 and 3.

In the configuration shown in FIG. 7, the image forming device 53a includes the printing instruction reception detecting unit, and when there is a request for printing from the client PC, the image forming device 53a detects the request for printing and selects a device using the device selection unit 66 according to desired printing conditions input from the client PC. The printing instruction device notification unit 67 notifies the selected image forming device and the client PC making the request for printing of information for the selected image forming device performing printing.

However, the image forming device 53a may first receive printing data, and the image forming device 53a may send the printing data to a corresponding image forming device for printing when the image forming device performing printing is selected.

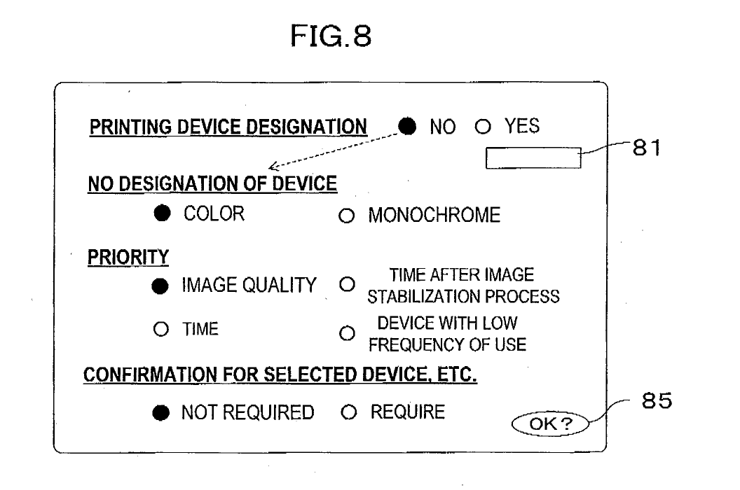

The image forming device 53a is, for example, a high-functionality MFP, and, an operation panel 53p thereof displays an input screen of desired printing conditions in the same manner as the client PC, for example, as shown in FIG. 8, and desired printing conditions can be input from the screen. For example, when “YES” is selected in the printing device designation, an image forming device is designated by inputting numbers in an input column 81. If the input is completed, the OK key is pressed. The screen shown in FIG. 8 is also displayed on a screen of the client PC, and thus desired printing conditions can be input any screen.

In this way, the input of desired printing conditions is possible from the image forming device, and desired printing conditions is input from the client PC, and then the desired printing conditions can be input again from the image forming device immediately before printing. In this way, since the desired printing conditions can be input twice, if there is a certain amount of time from the request for printing to the printing, there is an advantage in that a good printing process can be performed under the latest conditions such as when there is an image forming device which performs a new stabilization process during the time from the request to printing.

If input is performed using the operation panel of the image forming device 53a, a number is added to each option, the input can be easily performed by pressing a key belonging to the operation panel so as to input the number.

In the second embodiment as well, in the flow shown in FIG. 5 as described in the first embodiment, an image forming device satisfying desired printing conditions is selected. Thereafter, the image forming device 53a notifies the image forming device and the client PC, the client PC directly sends printing data to the image forming device performing printing, and the image forming device performs printing.

In addition, in the second embodiment, the device selection printing instruction unit 60 of the image forming device 53a shown in FIG. 7 is preferably in an operable state and preferably in an ON state at all time. In addition, even if the image forming device 53a is powered off, the device selection printing instruction unit 60 is preferably in an operable state at all time.

In addition, a print server is provided, and the print server has the printing instruction reception detecting unit 62. When the printing instruction reception detecting unit 62 of the printer server receives a request for printing from the client PC, the print server may make the device selection unit 66 of the image forming device 53a work.

According to the second embodiment, the client PC is not required to select an image forming device performing printing by itself. In addition, the print server is not necessary, which leads the configuration to be less complicated, and it is possible to perform printing according to desired printing conditions of the client PC using a predetermined image forming device.

In the second embodiment, printing image conditions from the client PC is input, and desired printing conditions including the time after image stabilization process can be input again in the image forming device. In this way, if there is a long time after the client PC makes a request for printing until either of the image forming devices performs printing, such as hold printing or private printing, for example, even in a case where image quality is prioritized, it is possible to perform printing with best image quality.

### Other Modified Examples

In the first embodiment, the print server has the device selection function of selecting a device satisfying desired printing conditions instructed by the client PC from a plurality of image forming devices, and, in the second embodiment, the MFP which is a high-functionality image forming device has the function. However, other servers or the like may have the selection function, or a printing selection device having a function of selecting an image forming device performing printing may be independently connected to a network.

In the first and second embodiments, the priority selects one of the image quality, the time, the time after image stabilization process, and the device with a low frequency of use. However, among them, two or more items including the time after image stabilization process may be selected. In this case, an appropriate image forming device is selected for the plural viewpoints.

In addition, the priority is not limited to the above-described four items, but other matters may be considered, or the priority may be less than the four items. In short, the priority may include one or more items. One image forming device may have a part having these functions.

For example, the print server or one image forming device connected to a network may have the working state detecting unit, and when there is a request for printing from the client PC, have a function of selecting one image forming device from the currently working image forming devices. In addition, the print server or one image forming device connected to a network may have the working state detecting unit and the image stabilization history storage unit, and when there is a request for printing from the client PC, selects an image forming device in which the time after the image stabilization process is performed is the shortest from a plurality of image forming devices in a working state.

In the first and second embodiments, the working state and printing type detecting units, and the image stabilization history storage unit are included, and a device is selected in consideration of a plurality of working states, printing types, and time from a time point when the image stabilization process is performed. However, the working state detecting unit is included such that only the working states attract attention, and when there is a request for printing from the client PC, an image forming device performing printing may be selected from image forming devices in a working state at that time. Further, the working state detecting unit and the image stabilization history storage unit are included, and when there is a request for printing, an image forming device in which a time after the image stabilization process is performed is the shortest may be selected from image forming devices in a working state.

In the first and second embodiments, a device instructing printing is the client PC, but is not limited to the PC and may be a client terminal.

In this way, according to the embodiments of the present invention, the client terminal is not required to select an image forming device performing printing by itself. In addition, since desired printing conditions are input in consideration of the time after image stabilization process, it is possible to obtain high image quality printing in a latest state.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming device system comprising:
a client terminal connected to a network;
a plurality of image forming devices that are connected to the network and can perform printing in response to a request for printing from the client terminal; and
a device selection unit that selects the image forming device according to desired printing conditions, including a time after an image stabilization process, input from the client terminal or one of the image forming devices when there is a request for printing from the client terminal.

2. The system according to claim 1, further comprising a working state detecting unit that detects working states of the plurality of image forming devices, wherein the device selection unit selects an image forming device performing printing from currently working image forming devices among the plurality of image forming devices which are detected by the working state detecting unit when there is a request for printing.

3. The system according to claim 2, further comprising an image stabilization history storage unit that detects a time after an image stabilization process in the plurality of image forming devices is performed,
wherein the device selection unit selects an image forming device in which the time after an image stabilization process is performed is the shortest from the plurality of image forming devices based on the information of the image stabilization history storage unit.

4. The system according to claim 1, further comprising:
a printing type detecting unit that detects printing types of the plurality of image forming devices in advance;
an image stabilization history storage unit that stores a time after an image stabilization process in the plurality of image forming devices is performed; and
a working state detecting unit that detects working states of the plurality of image forming devices.

5. The system according to claim 4, wherein an image forming device which prints desired printing conditions input based on outputs from the printing type detecting unit and the image stabilization history storage unit is selected from image forming devices in a working state which is detected by the working state detecting unit when there is a request for printing from the client terminal.

6. A printing selection device comprising:
a working state detecting unit that detects working states of a plurality of image forming devices connected to a network;
an image stabilization history storage unit that stores a time after an image stabilization process in the plurality of image forming devices is performed; and
a device selection unit that selects an image forming device which performs printing based on outputs from the image stabilization history storage unit, from image forming devices in a working state detected by the working state detecting unit when there is a request for printing from a client terminal which is connected to the network and which instructs printing.

7. The device according to claim 6, further comprising a printing type detecting unit that detects in advance printing types of the plurality of image forming devices connected to the network,
wherein the device selection unit selects an image forming device which performs printing based on outputs from the image stabilization history storage unit and the printing type detecting unit, from image forming devices in a working state detected by the working state detecting unit when there is a request for printing from a client terminal which is connected to the network and which instructs printing.

8. A print server comprising:
a printing type detecting unit that detects in advance printing types of a plurality of image forming devices connected to a network;
an image stabilization history storage unit that stores a time after an image stabilization process in the plurality of image forming devices is performed;
a working state detecting unit that detects working states of the plurality of image forming devices;
a printing instruction reception detecting unit that detects an instruction for a request for printing from the client terminal connected to the network;
a device selection unit that selects an image forming device performing printing from the plurality of image forming devices based on outputs from the printing type detecting unit, the image stabilization history storage unit, and the working state detecting unit, according to desired printing conditions input from the client terminal or one of the plurality of image forming devices; and
a printing instruction device notification unit that instructs the image forming device selected by the device selection unit and the client terminal which instructs the request for printing to perform printing.

9. The print server according to claim 8, wherein the device selection unit selects an image forming device satisfying the desired printing conditions from image forming devices detected by the working state detecting unit when there is the request for printing from the client terminal.

10. The print server according to claim 9, wherein in the desired printing conditions, a priority includes at least one of image quality, time, time after image stabilization process, and device with a low frequency of use.

11. The print server according to claim 10, wherein the device selection unit performs the selection based on a plurality of desired printing conditions.

12. An image forming device connected to a network comprising:
a printing data storage unit that can store printing data input from a client terminal connected to a network; and
a printing unit that prints the printing data stored in the printing data storage unit when satisfying desired printing conditions including a time after image stabilization process, which are input when there is a request for printing from the client terminal.

13. The device according to claim 12, wherein desired printing conditions input from the client terminal or the image forming device are sent to a print server connected to the network, and the print server checks whether or not to satisfy the desired printing conditions based on printing types, working states, and a time after image stabilization process of image forming devices, and when satisfying the conditions, the printing unit of the image forming device performs printing requested by the client terminal.

14. The device according to claim 12, further comprising:
a printing type detecting unit that detects printing types of a plurality of image forming devices connected to the network in advance;
an image stabilization history storage unit that stores a time after an image stabilization process in the plurality of image forming devices is performed;
a working state detecting unit that detects working states of the plurality of image forming devices; and
a device selection unit that selects an image forming device performing printing from the plurality of image forming devices based on outputs from the printing type detecting unit, the image stabilization history storage unit, and the working state detecting unit, according to printing conditions input from the client terminal which is connected to the network and instructs printing.

15. The device according to claim 14, wherein the device selection unit selects an image forming device satisfying the desired printing conditions from image forming devices detected by the working state detecting unit when there is the request for printing from the client terminal.

16. The device according to claim 15, wherein in the desired printing conditions, a priority includes at least one of image quality, time, time after image stabilization process, and device with a low frequency of use.

17. The device according to claim 16, wherein the device selection unit performs the selection based on a plurality of desired printing conditions input from the client terminal.

18. A selection method of an image forming device comprising:
selecting an image forming device performing printing from a plurality of image forming devices, connected to a network, including a predetermined image forming device, based on desired printing conditions, when there is a request for printing from a client terminal connected to the network and the desired conditions including a time after an image stabilization process for the printing are input from the client terminal or the predetermined image forming device.

19. The method according to claim 18, wherein the selection of an image forming device performing printing is performed by detecting working states of the plurality of image forming devices and by selecting an image forming device performing printing from working image forming devices.

20. The method according to claim 19, wherein in the desired printing conditions, a priority includes at least one of image quality, time, time after image stabilization process, and device with a low frequency of use.
